(19) United States
(12) Patent Application Publication
(10) Pub. No.: US 2006/0228972 A1
(43) Pub. Date: Oct. 12, 2006

(54) Aging method and aging apparatus for plasma display panel

(76) Inventors: Koji Akiyama, Neyagawa-shi (JP); Koji Aoto, Nishinomiya-shi (JP); Masaaki Yamauchi, Takatsuki-shi (JP); Takashi Aoki, Ibaraki-shi (JP)

Correspondence Address: RATNERPRESTIA, P O BOX 980, VALLEY FORGE, PA, 19482-0980, US

(21) Appl. No.: 10/552,396

(22) PCT Filed: Jul. 16, 2004
(86) PCT No.: PCT/JP04/10531

§ 371 Date: Oct. 7, 2005

(30) Foreign Application Priority Data
Jul. 18, 2003 (JP) 2003199265

(51) Int. Cl. H01J 9/24; H01J 61/52; H01J 17/49; H01J 9/00

(52) U.S. Cl. 445/24; 313/582; 313/46

(57) ABSTRACT

An aging method and an aging device are provided by which a plasma display panel that reduces the generation of irregular color and that has a high display quality can be obtained. An aging method and an aging apparatus for plasma display panels are disclosed which enable to obtain a plasma display panel with high display quality wherein color irregularities are suppressed. The aging apparatus for plasma display panels comprises a plurality of fans. When air is blown to a plasma display panel using the fans during aging of the plasma display panel, at least the direction or the amount of air blow by at least one of the fans is changed so that the temperatures of image display regions in the plasma display panel can be uniform, thereby suppressing color irregularities.

### FIELD OF THE INVENTION

The present invention relates to an aging method and an aging device of a plasma display panel for causing electric discharge between electrodes to generate plasma to display an image.

### BACKGROUND ART

A plasma display panel (hereinafter simply referred to as PDP or panel) is a display device having a superior visibility that is characterized in having a large screen, a thin thickness, and a light weight. PDP has two types of electric discharge methods of the AC type method and the DC type method and have two types of electrode structures of the surface electric discharge type one and the opposing electric discharge type one. Currently, a PDP that is the AC type and that is the surface electric discharge-type has been mainly used because this is suitable to provide a higher definition and can be manufactured in an easy manner.

The AC-type-and-surface-electric-discharge-type PDP has a structure as shown in FIG. 8. On transparent substrate 1 (e.g., glass substrate) at the front face side, a plurality of display electrodes 4 are provided. Each display electrode 4 has a pair of strip-shaped scan electrode 2 and strip-shaped sustain electrode 3. Dielectric layer 5 is provided so as to cover display electrode 4. Dielectric layer 5 has thereon protection layer 6. On substrate 7 at the back face side, there are provided a plurality of strip-shaped address electrodes 9 covered by insulating layer 8 to have a cubic interchange with display electrode 4. Insulating layer 8 has thereon a plurality of ribs 10 arranged in parallel with address electrodes 9. Ribs 10 have therebetween insulating layer 8 on which fluorescent material layer 11 is provided. Address electrode 9 is provided between neighboring ribs 10.

Front face-side substrate 1 and back face-side substrate 7 as described above are provided to be opposed to each other while having a minute electric discharge space therebetween so that display electrode 4 is orthogonal to address electrode 9. The periphery of substrate 1 and substrate 7 is sealed by sealing glass frit. The electric discharge space is filled with electric discharge gas (e.g., mixed gas of neon (Ne) and xenon (Xe)). The electric discharge space is divided by rib 10 to have a plurality of subdivisions. Each subdivision includes fluorescent material layers 11 having light emission of red, green, and blue that are arranged sequentially. A part at which display electrode 4 intersects with address electrode 9 has an electric discharge cell so that one pixel is provided by three electric discharge cells having fluorescent material layers 11 providing light emission of the respective colors. A region including these electric discharge cells constituting this pixel is an image display region. The periphery of the image display region is a non-display region providing no image display (e.g., region including sealing glass frit).

In the PDP having the structure as described above, scan electrode 2 in an electric discharge cell lighted for image display is applied with a scan pulse simultaneously with the application of a writing pulse to address electrode 9, thereby providing address electric discharge between canning electrode 2 and address electrode 9. Thereafter, an alternately-inversed periodical sustain pulse is applied between scan electrode 2 and sustain electrode 3 to provide, in the electric discharge cell having provided the address electric discharge, a sustain electric discharge between scan electrode 2 and sustain electrode 3, thereby performing an image display.

The PDP having the structure as described above is mainly provided by two parts of the front face plate and the back face plate and is manufactured in a manner as described below.

The front face plate is manufactured by a procedure as described below. First, front face-side substrate 1 has thereon an electrode made of a transparent conductive film. Thereafter, an electrode material (e.g., silver (Ag)) is printed and sintered to provide a bus electrode, thereby providing scan electrode 2 and sustain electrode 3 on which a dielectric glass material is coated and sintered, thereby forming dielectric layer 5. Thereafter, vapor deposition of magnesium oxide (MgO) is performed to provide protection layer 6. As a result, the front face plate is prepared.

The back face plate is manufactured by a procedure as described below. First, an electrode material (e.g., Ag) is printed and sintered on substrate 7 at the back face side to provide address electrode 9. Then, glass material is coated and sintered to provide insulating layer 8. Next, insulating layer 8 has thereon ribs 10 between which fluorescent material layer 11 is provided by coating and sintering of fluorescent material. As a result, the back face plate is prepared.

After the respective predetermined steps, the periphery of the back face plate is coated with sealing glass frit and the back face plate is put with the front face plate. Thereafter, the resultant lamination is subjected to a sealing step for heating and melting the sealing glass frit so that the periphery of the front face plate and the back face plate are sealed. Then, an exhaust step is performed in which impure gas is exhausted from the electric discharge space provided between the front face plate and the back face plate. Thereafter, the electric discharge space is sealed with electric discharge gas with a predetermined pressure. As a result, the PDP is manufactured.

In the PDP immediately after the manufacture by the steps as described above, an operating voltage (which is a voltage required for lighting the entire surface of the PDP) is generally high and the electric discharge itself is unstable. Thus, a manufacture process of PDP includes an aging step in which an alternation voltage is applied mainly between scan electrode 2 and sustain electrode 3 so that electric discharge (aging electric discharge) is forcedly caused in all electric discharge cells for a predetermined time. This aging reduces the operating voltage and equalize and stabilize the electric discharge characteristics. Another aging method has been suggested in which a fan is provided at the upper part of a PDP so that the PDP is cooled by the fan during the aging.

However, this aging method has a disadvantage in that, when the fan is used to cool a PDP during the aging process, the PDP displays an irregularly colored image.

### SUMMARY OF THE INVENTION

The present invention is an aging method for performing an aging of a PDP using an aging device including an air blowing means for cooling a PDP, wherein the PDP is cooled during the aging while changing at least one of a direction or amount of air blown from the air blowing means.

The present invention is an aging device of a PDP, comprising: an air blowing means for cooling a PDP and an aging power source for applying a predetermined voltage to the PDP to cause an aging electric discharge, and wherein the air blowing means is a means for changing, during an aging, at least one of an air blowing direction or an air blowing amount while cooling the PDP.

### BRIEF DESCRIPTION OF THE DRAWINGS

FIG. 1 is a schematic plan view illustrating an aging process by a PDP aging device according to Embodiment 1 of the present invention.

FIG. 2 schematically shows the cross section taken at the line A-A in FIG. 1.

FIG. 3 shows the connection between each electrode in a PDP and an aging power source in the PDP aging device.

FIG. 4 is a waveform chart illustrating a voltage pulse outputted from the aging power source in the PDP aging device.

FIG. 5 is a partial cross sectional view of the PDP aging device in Embodiment 2 of the present invention.

FIG. 6 is a partial cross sectional view of the PDP aging device in Embodiment 3 of the present invention.

FIG. 7 is a partial cross sectional view of the PDP aging device in Embodiment 4 of the present invention.

FIG. 8 is a partial perspective view of a PDP.

### DETAILED DESCRIPTION OF PREFERRED EMBODIMENTS

Hereinafter, one embodiment of the present invention will be described with reference to the drawings.

### Embodiment 1

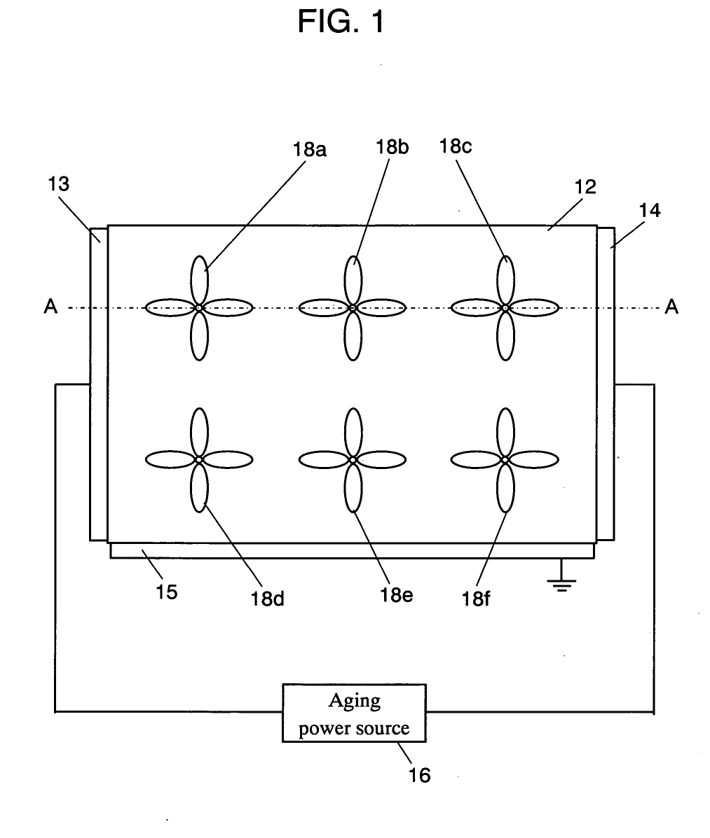

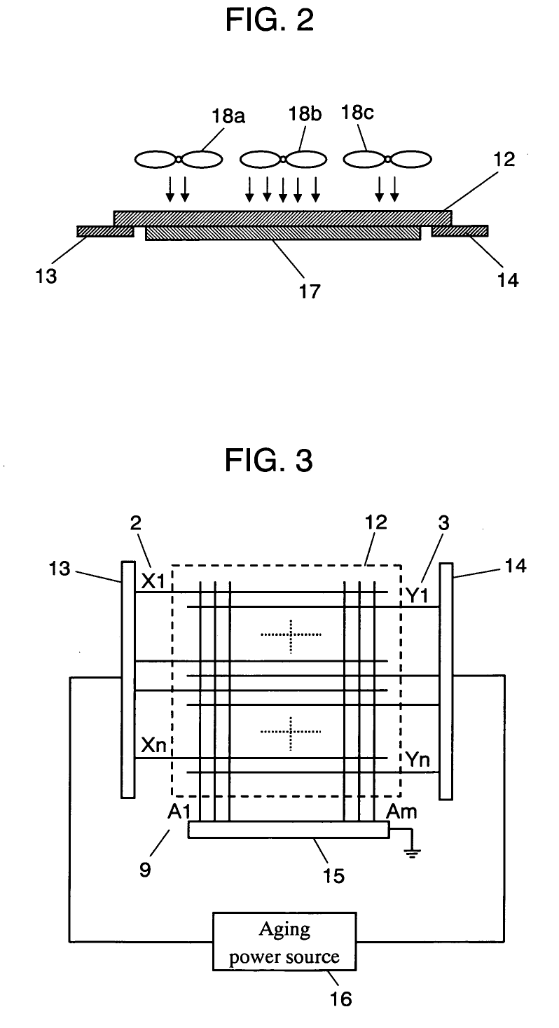

FIG. 1 is a schematic plan view illustrating an aging process by a PDP aging device according to Embodiment 1 of the present invention. FIG. 2 schematically shows the cross section taken at the line A-A in FIG. 1. FIG. 3 shows the connection between each electrode in a PDP and aging power source 16 in the PDP aging device.

First, as shown in FIG. 3, scan electrodes 2 (X1, X2, . . . , Xn) of panel 12 are commonly connected by short circuit means 13, sustain electrodes 3 (Y1, Y2, . . . , Yn) are commonly connected by short circuit means 14, and address electrodes 9 (A1, A2, . . . , Am) are commonly connected by short circuit means 15. Scan electrodes 2 and sustain electrodes 3 are connected to aging power source 16 via short circuit means 13 and short circuit means 14, respectively. Address electrode 9 is grounded via short circuit means 15. Aging power source 16 is a means for applying a predetermined voltage to a PDP to cause an aging electric discharge. Address electrode 9 may be applied with a voltage pulse. Alternatively, address electrode 9 may be placed no voltage.

As shown in FIG. 1 or FIG. 2, panel 12 is provided on back plate 17 having a high heat conductance. Back plate 17 in this layout preferably has a thermal conductivity equal to or higher than 0.5 W/m·K. An air blowing means for cooling a surface of panel 12 by blowing air is disposed above panel 12. This air blowing means has a plurality of air blowing devices (hereinafter referred to as fans) 18a to 18f that are arranged to have an appropriate space of about 10 cm thereamong. The plurality of fans 18a to 18f are attached to an air blowing device frame (not shown) that is provided for supporting the plurality of fans 18a to 18f so that the plurality of fans 18a to 18f are fixed at predetermined positions. Although FIG. 1 shows an example in which six fans 18a to 18f are disposed above panel 12, the number or layout of fans constituting the air blowing means is desirably determined in an appropriate manner depending on the size of panel 12 or the fan.

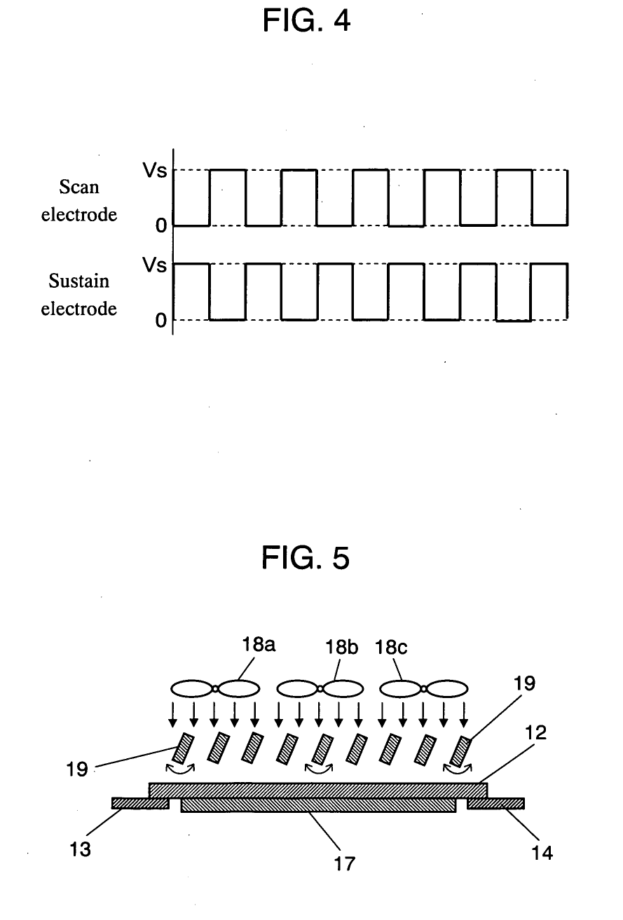

FIG. 4 is a waveform chart illustrating voltage pulses outputted from aging power source 16 in a PDP aging device in Embodiment 1 of the present invention. Aging power source 16 alternately outputs rectangular pulses (frequency: 20 kHz to 100 kHz) of voltage Vs that are applied to scan electrode 2 and sustain electrode 3, respectively. As a result, aging electric discharge is caused between scan electrode 2 and sustain electrode 3. Then, a plurality of fans 18a to 18f as shown in FIG. 1 and FIG. 2 are used to blow air to the surface of panel 12 to cool panel 12 while causing the aging electric discharge, thereby causing the aging of panel 12.

The following section will describe the reason why a PDP that is aged while being cooled by a fan displays an irregularly colored image based on the result examined by the inventors of the present application.

PDPs are characterized in having a thin thickness and a large screen and mainly have large sizes ranging from a diagonal length of 32 inch to a diagonal length of 60 inch. Due to this, an aging process for such a large-sized PDP is performed such that the panel is cooled by arranging and fixing a plurality of fans to blow air to the surface of the panel. The authors investigated in detail the temperature distribution during the aging when the respective fans are operated in the same manner. The result was that the cooling by a plurality of arranged fans causes distribution of air flows at the surface of the panel (i.e., a part at which air flows smoothly and a part at which air does not flow well to have stagnation). This causes an image display region of the panel to have a high temperature region having a high temperature and a low temperature region having a low temperature that are caused to be close to each other, which tends to cause a remarkable temperature difference in a short distance.

An electric discharge start voltage between the respective electrodes in the panel changes depending on the temperature of the panel. Due to this reason, the difference in temperature in the image display region of the panel during an aging causes the difference in easiness of aging. Specifically, an image display region having a high temperature has a small electric discharge start voltage and thus has a large amount of electric discharge current even with the same application voltage, thus promoting the aging. On the contrary, an image display region having a low temperature has a large electric discharge start voltage and has a small amount of electric discharge current and thus causes the aging to be promoted slower than in the case of the high temperature region. As a result, the high temperature region and the low temperature region have different rates at which the aging is promoted. This causes, when the aging process is completed, a further increased difference in the electric discharge start voltage in image display regions of the panel. The difference in the electric discharge start voltage as described above causes the difference in electric discharge current (i.e., difference in brightness) when the panel is operated, causing irregular color to remarkably deteriorate the display quality. The irregular color is increased particularly when a high temperature region and a low temperature region are provided to be close to each other during the aging.

As described above, it was found that a panel cooled by a plurality of similarly-operated fans causes the surface of the panel to have a part at which air flows smoothly and a part at which air does not flow well to have stagnation, which causes the image display region of the panel to have a high temperature region and a low temperature region that are close to each other, causing the panel to display an irregularly-colored image to severely deteriorate the display quality.

To prevent this, an aging device in Embodiment 1 of the present invention is structured such that fans 18a to 18f are rotated with a periodically-changed rotational frequency (e.g., rotational frequency changed from low rotation frequency, high rotation frequency, low rotation frequency, high rotation frequency, . . . ). The rotational frequency is periodically changed with a cycle of 2 seconds to 1 minute, for example. In Embodiment 1 of the present invention, fans 18a to 18f are rotated with a rotational frequency changed in a range from 100 rpm to 5000 rpm so that the rotational frequency is periodically changed between a low rotation frequency and a high rotation frequency. Fans 18a to 18f also may be stopped instead of being rotated with a low rotation frequency. The change of the rotational frequency of fans 18a to 18f as described above changes the amount of air blown by fans 18a to 18f to change the amount of air blown to the surface of panel 12 with time. The change in the air blowing amount as described above causes a change in stagnation of air flowing at the surface of panel 12 to suppress the surface of panel 12 from having a region having air stagnation. As a result, the surface of panel 12 is evenly blown with air from fans 18a to 18f with a temporal change in the air blowing amount. This allows an image display region of the surface of panel 12 to have equalized temperatures to suppress a low temperature region and a high temperature region close to each other (which is a cause of the irregular color) from being caused.

As described above, Embodiment 1 of the present invention changes the air blowing amount of at least one of fans 18a to 18f during an aging so that the surface of panel 12 is evenly blown with air to equalize, during the aging, the temperatures in the image display region at the surface of panel 12. In this way, the irregular color is prevented from being caused to realize a PDP having a superior display quality.

In Embodiment 1 of the present invention, fans 18a to 18f are divided into two groups of the first group and the second group so that the first group includes fan 18a to 18c and the second group includes fan 18d to 18f, for example. Then, an operation for causing fans in the first group to be rotated with a high rotation frequency and causing fans in the second group to be rotated with a low rotation frequency or to be stopped and an operation for causing fans in the first group to be rotated with a low rotation frequency or to be stopped and causing fans in the second group to be rotated with a high rotation frequency are repeated in an alternate manner. In this way, an amount of air blown from fans 18a to 18f is changed to evenly blow air to the surface of panel 12. However, the present invention is not limited to this structure. For example, another structure also may be used in which the first group is provided with a fixed rotational frequency while the second group is provided with a rotational frequency to be changed with a cycle. Fans 18a to 18f also may be divided into groups in a different manner. For example, the first group may include fan 18a, 18c, and 18e while the second group may include fan 18b, 18d, and 18f. Alternatively, fans 18a to 18f also may be divided into three or more groups. Embodiment 1 of the present invention may use any structure so long as the structure allows the fans in each group to have a controlled rotational frequency to change the air blowing amount so that a region in the surface of panel 12 having stagnated air can be suppressed from being caused. How to operate fans 18a to 18f or how to divide fans 18a to 18f is desirably determined depending on the size of panel 12 or the size or the air blowing capacity of a fan, for example.

Fans 18a to 18f are preferably configured such that fans 18a to 18f are rotated with rotational frequencies each of which is changed with a time difference or are rotated with rotational frequencies that are changed with different cycles. The reason is that the configuration as described above makes it easy to suppress the stagnation of air. However, when fans 18a to 18f have rotational frequencies that are changed in a synchronized manner, the surface of panel 12 tends to have air stagnation. Thus, the synchronized change of the rotational frequencies is not preferable. Fans 18a to 18f also may have rotational frequencies that are changed with 1/f fluctuation or 1/f² fluctuation. Fans 18a to 18f also may have rotational frequencies that are not changed with a cycle but are changed in a completely random manner.

Embodiment 1 of the present invention uses panel 12 that has a diagonal length of 42 inch, the number of pixels of 1028×768 (total number m of address electrodes 9=1028×3, total number n of scan electrodes 2 and sustain electrodes 3=768) (hereinafter referred to as panel 12a). Panel 12a is sealed with mixed gas that consists of Ne and Xe and that has a Xe volume ratio of 10% to 40%. Fans 18a to 18f are divided into two groups as described above. An operation for causing fans in the first group to be rotated with a high rotation frequency and causing fans in the second group to be stopped and an operation for causing fans in the first group to be stopped and causing fans in the second group to be rotated with a high rotation frequency were alternately repeated while an aging process is performed for 8 hours. In this aging, scan electrode 2 and sustain electrode 3 were applied with a fixed voltage Vs of 270V. After the aging, this panel 12a was investigated with regards to the display characteristic. The result was that the entire face of panel 12a showed an even lighting at an operating voltage of 185V Panel 12a at this voltage showed a uniform display characteristic and irregular color or difference in brightness cannot be visually recognized and thus a superior display quality could be obtained.

As a comparison example, panel 12 having the same structure as that of the above-described one was subjected to an aging having the same conditions as those of the above-described aging except for that fans 18a to 18f are provided with a fixed rotational frequency to provide a constant air blowing amount. Then, panel 12 of this comparison example (hereinafter referred to as panel 12b) was also investigated with regards to the display characteristic. The result was that the image display region showed a wide distribution of electric discharge start voltages and thus the operating voltage was required to be increased to 195V in order to allow the entire face of panel 12b to have uniform lighting. Even at this voltage condition, a total white display showed regions slightly colored with magenta and yellow, thus showing a display quality that is clearly inferior to that of panel 12a.

In order to investigate the cause of this difference, panels 12a and 12b were investigated with regards to the temperature distribution in the image display region of the panel during the aging. The result was that, when the temperature increase was almost saturated, panel 12b had a temperature distribution of 73±20° C. while panel 12a had a temperature distribution of 76±10° C. Thus, panel 12a showed uniform temperatures in the image display region when compared to panel 12b. It was also found that panel 12b showed portions having low temperatures that showed high electric discharge start voltages in the evaluation of the display characteristic and that were caused at almost the same positions as those at which irregular colors were caused.

As described above, Embodiment 1 of the present invention allows at least one of a plurality of fans 18a to 18f to change air blowing amounts during an aging so that air stagnation on the surface of panel 12 can be suppressed. This can equalize temperatures in the image display region of the panel when compared to a case where the air blowing amount of an air blowing means is not changed, thus providing an aging in a more uniform manner. As a result, irregular color can be suppressed from being caused to provide a PDP having a superior display quality.

### Embodiment 2

FIG. 5 is a partial cross sectional view of a PDP aging device in Embodiment 2 of the present invention and is a schematic block diagram for explaining an aging method in Embodiment 2. As shown in FIG. 5, a plurality of fans 18a to 18c fixed at predetermined positions are disposed above panel 12 placed on back plate 17. Panel 12 and fans 18a to 18c have therebetween louver 19 working as an air blowing direction changeable means for changing the direction along which air is blown from fans 18a to 18c. Louver 19 is operated, as shown by the arrow in FIG. 5, so that an air blowing direction to panel 12 is changed and louver 19 is oscillated along a direction that is in parallel with scan electrode 2 and sustain electrode 3 of panel 12 (left-and-right direction in FIG. 5). Louver 19 is structured so that the oscillation angle can be changed with a predetermined cycle (e.g., cycle within a range from 1 second to 1 minute). The aging device used in Embodiment 2 of the present invention as described above includes, as an air blowing means for blowing air to the surface of panel 12 to cool panel 12, a plurality of fans 18a to 18c and louver 19.

When an aging is performed in Embodiment 2 of the present invention, air is blown from fans 18a to 18c via louver 19 to the surface of panel 12 while operating louver 19 so that directions along which air is blown from fans 18a to 18c are changed. As a result, directions along which air is blown to the surface of panel 12 are changed in a temporal manner. This allows air blown from the air blowing means to the surface of panel 12 to be provided evenly, thus suppressing a region having air stagnation at the surface of panel 12 from being caused. This can equalize temperatures in the image display region of panel 12 when compared to the case of panel 12b described in the comparison example of Embodiment 1, thus suppressing a low temperature region and a high temperature region close to each other from being caused.

Panel 12 having been subjected to an aging by this aging device was investigated with regards to the display characteristic as in the case of Embodiment 1. The result was that panel 12 showed a superior display quality equal to that of Embodiment 1.

The number or layout of the respective fans for constituting the air blowing means is desirably determined depending on the size of panel 12 or the size or air blowing capacity of the fan, for example. Although louver 19 in FIG. 5 is operated in a direction in parallel with scan electrode 2 or sustain electrode 3, louver 19 also may be operated in an appropriately determined direction.

### Embodiment 3

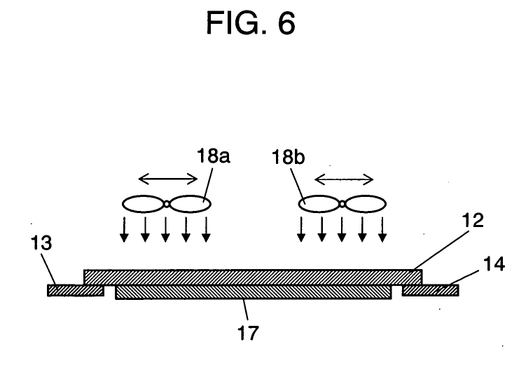

FIG. 6 is a partial cross sectional view of a PDP aging device in Embodiment 3 of the present invention and is a schematic block diagram for explaining an aging method in Embodiment 3. In this aging device, an, air blowing means having a plurality of fans is disposed above panel 12 placed on back plate 17. At least one of the plurality of fans (e.g., fans 18a and 18b) are structured so as to be moved in a direction in parallel with panel 12, as shown by the arrow in FIG. 6. When an aging is performed, fans 18a and 18b are moved above panel 12 with a predetermined cycle (e.g., cycle within a range from 5 seconds to 1 minute). For example, among a plurality of fans arranged in a matrix-like manner, fans 18a and 18b provided in a specific row or column have a reciprocating motion in parallel with panel 12 as shown in FIG. 6. As described above, Embodiment 3 of the present invention allows at least one of a plurality of fans constituting an air blowing means (e.g., fans 18a and 18b) to be provided to be moved in parallel with panel 12 so that air blowing directions from fans 18a and 18b are changed and the air blowing amount and the air blowing direction at the surface of panel 12 are changed in a temporal manner. As s result, air can be evenly blown from the air blowing means to the surface of panel 12, thus suppressing the surface of panel 12 from having a region in which air is stagnated. Therefore, temperatures in the image display region of panel 12 can be equalized when compared to the case of panel 12b described in the comparison example in Embodiment 1 to suppress a low temperature region and a high temperature region close to each other from being caused.

Panel 12 having been subjected to an aging by this aging device was investigated with regards to the display characteristic as in the case of Embodiment 1. The result was that panel 12 showed a superior display quality equal to that of Embodiment 1.

In Embodiment 3 of the present invention, all of the plurality of fans arranged in a matrix-like manner to constitute the air blowing means may be moved in the same direction and with the same rate. Alternatively, fans arranged in a certain column or row also may be moved in a direction opposite to a direction along which fans arranged in another column or row are moved. Alternatively, fans in each column or row also may be moved with a different rate. Alternatively, a plurality of fans arranged in a line may be moved in the same direction or each one of the plurality of fans may be moved at a different movement speed or in a different moving direction. Alternatively, fans may be moved in a row direction or in a column direction or may be moved in a predetermined direction other than the row direction and the column direction. Fans also may not be moved in a straight line but may be moved along a closed curve (e.g., circle, ellipse, rectangular).

The number or layout of the respective fans for constituting the air blowing means is desirably determined depending on the size of panel 12 or the size or air blowing capacity of the fan, for example. One fan also may be provided so that the fan is moved so that air can be blown to the entire surface of panel 12.

### Embodiment 4

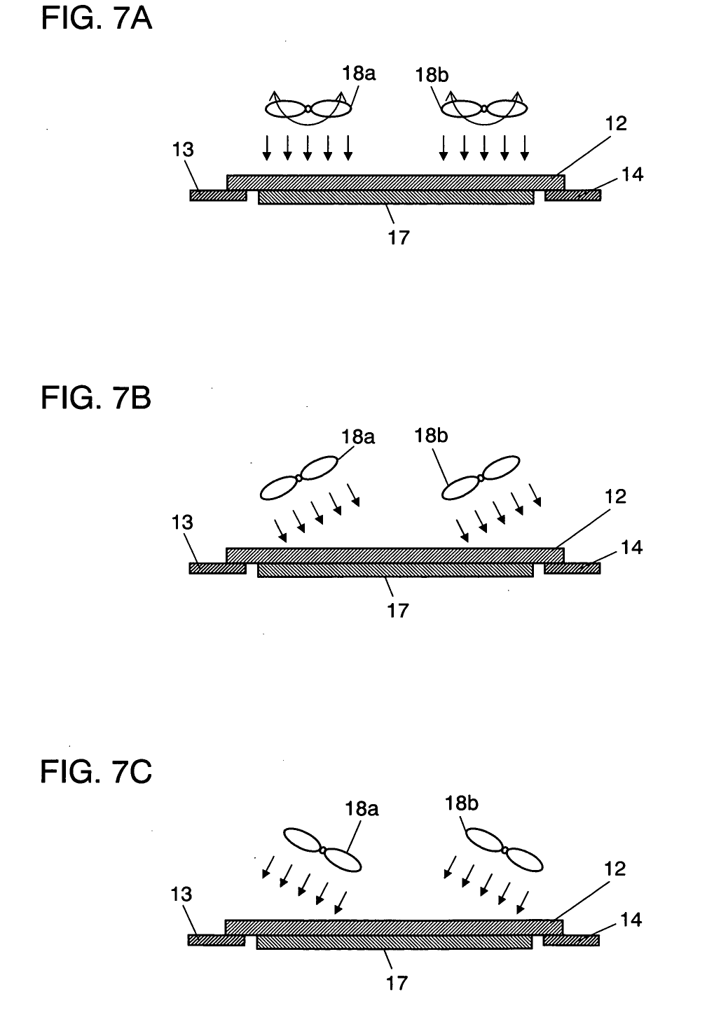

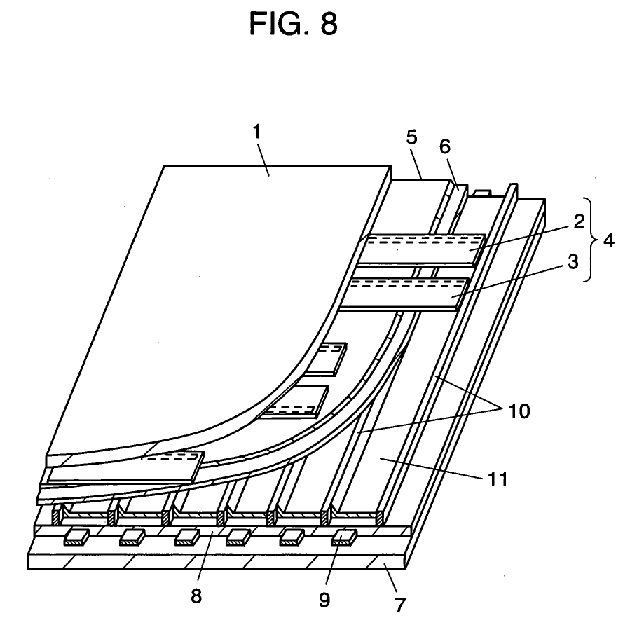

FIG. 7 is a partial cross sectional view of a PDP aging device in Embodiment 4 of the present invention and is a schematic block diagram for explaining an aging method in Embodiment 4. In this aging device, an air blowing means having a plurality of fans is disposed above panel 12 placed on back plate 17. This aging device is structured such that at least one of a plurality of fans (e.g., fans 18a and 18b)is capable of changing in directions. In Embodiment 4 of the present invention, when an aging is performed, fans 18a and 18b have an oscillating movement with a predetermined cycle (e.g., cycle within a range from 2 seconds to 1 minute) so that fans 18a and 18b can blow air in different directions. For example, fans 18a and 18b have an oscillating movement as shown in FIG. 7B and FIG. 7C such that fans 18a and 18b are oscillated in the left-and-right direction to panel 12 so that the air blowing direction to panel 12 can be changed. In this way, Embodiment 4 of the present invention changes the direction of fans 18a and 18b (which are at least one of a plurality of fans constituting the air blowing means) to change the air blowing amount and the air blowing direction to the surface of panel 12 in a temporal manner As a result, the air blowing means can blow air to the surface of panel 12 in an even manner, thus preventing the surface of panel 12 from having a region having stagnated air. This can equalize temperatures in the image display region of the panel 12 when compared to the case of panel 12b described in the comparison example in Embodiment 1, thus suppressing a low temperature region and a high temperature region close to each other from being caused.

Panel 12 having been subjected to an aging by this aging device was investigated with regards to the display characteristic as in the case of Embodiment 1. The result was that panel 12 showed a superior display quality equal to that of Embodiment 1.

A plurality of fans may have an oscillating movement to draw a straight or circular line. Alternatively, all fans may have the same cycle or direction of the oscillating movement or the respective fans may have different cycles or directions of the oscillating movement. Alternatively, one of the fans may be fixed without having an oscillating movement while the other fans may have an oscillating movement. Alternatively, at least one of the fans may have an oscillating movement while changing the rotational frequency thereof in a temporal manner.

The number or layout of the respective fans for constituting the air blowing means is desirably determined depending on the size of panel 12 or the size or air blowing capacity of the fan, for example. One fan also may be provided so that the fan has an oscillating movement to change the air blowing direction so that air can be blown to the entire surface of panel 12.

As described above, the embodiments of the present invention allow, when the air blowing means is used to blow air to a PDP during an aging, at least one of the air blowing direction or the air blowing amount to be changed. This can suppress the surface of panel 12 from having a region having stagnated air. This can equalize temperatures in the image display region of the panel 12 when compared to the case of panel 12b described in the comparison example in Embodiment 1, thus performing the aging in a more uniform manner. As a result, a PDP that has reduced irregular color and that has a superior display quality can be manufactured.

In the above-described embodiments, in order to allow temperatures of panel 12 during aging to be equalized with a further lower temperature, the upper face of panel 12 placed on back plate 17 also may be closely attached with a plate having a high heat conductance that is the same as that of the back plate 17. Alternatively, the lower side of back plate 17 also may be provided with fan(s) in order to cool back plate 17, thus lowering the temperature in an easier manner.

When a heat insulating member having a low heat conductance (e.g., heat insulating member having a thermal conductivity equal to or lower than 0.1 W/m·K) is used as back plate 17, panel 12 during the aging has a temperature that is higher than that of back plate 17 having a high heat conductance, which tends to cause an irregular color. However, the use of the present invention can provide uniform distribution of temperatures in the image display region of panel 12 and thus can provide panel 12 having a superior display quality as obtained in the above-described cases, even if a heat insulating member having a low heat conductance is used.

Panel 12 in the above-described embodiments was filled with mixed gas of Ne and Xe in which a Xe volume ratio was 10% to 40%. However, even when panel 12 is filled with gas having a Xe volume ratio lower than 10%, the use of the present invention can provide the same effect as those in the above cases. Panel 12 filled with gas having a Xe volume ratio lower than 10% was subjected to an experiment. The result was that panel 12 showed no irregular color even when the image display region of panel 12 during the aging had a distribution of temperatures of ±15° C. The reason why a low Xe volume ratio tends to suppress the irregular color when compared to a high Xe volume ratio even when the image display region of panel 12 during the aging has a somewhat wide distribution of temperatures is presumably that an operating voltage is reduced when compared to a case of a high Xe volume ratio to reduce an electric discharge current and thus panel 12 has a reduced brightness. Due to this reason, the use of the present invention is particularly effective for a high Xe volume ratio because the high Xe volume ratio requires a more uniform distribution of temperatures in the image display region of panel 12 during the aging. The use of the present invention also can provide the effect as described above to a panel filled with gas having a composition other than Ne—Xe.

### INDUSTRIAL APPLICABILITY

As described above, the present invention allows, when the air blowing means is used to cool a PDP while applying a predetermined voltage to the PDP to cause an aging electric discharge to perform an aging, the PDP to be cooled while changing at least one of the direction or amount of air blown from the air blowing means. This provides an advantageous effect in which a PDP that has reduced irregular color and that has a superior display quality can be manufactured.

What is claimed is:

1. An aging method for performing an aging of a plasma display panel using an aging device including an air blowing means for cooling a plasma display panel, the method comprising:
cooling the plasma display panel during the aging while changing at least one of a direction or amount of air blown from the air blowing means.

2. The aging method of a plasma display panel according to claim 1, wherein the air blowing means includes a plurality of air blowing devices, and an air blowing amount of at least one of the plurality of air blowing devices is changed.

3. The aging method of a plasma display panel according to claim 1, wherein the air blowing means includes a plurality of air blowing devices and an air blowing direction changeable means provided between the plurality of air blowing devices and a plasma display panel so that, during an aging, the air blowing direction changeable means changes directions of air blown from the plurality of air blowing devices.

4. The aging method of a plasma display panel according to claim 1, wherein the air blowing means includes a plurality of air blowing devices so that, during an aging, at least one of the plurality of air blowing devices is moved.

5. The aging method of a plasma display panel according to claim 1, wherein the air blowing means includes a plurality of air blowing devices so that, during an aging, at least one of the plurality of air blowing devices changes in a direction.

6. An aging device of a plasma display panel, comprising: an air blowing means for cooling a plasma display panel and an aging power source for applying a predetermined voltage to the plasma display panel to cause an aging electric discharge,
wherein the air blowing means is a means for changing, during an aging, at least one of an air blowing direction or an air blowing amount while cooling the plasma display panel.

7. The aging device of a plasma display panel according to claim 6, wherein the air blowing means includes a plurality of air blowing devices, and
the air blowing means is a means for changing, during an aging, the air blowing amount of at least one of the plurality of air blowing devices.

8. The aging device of a plasma display panel according to claim 6, wherein the air blowing means includes a plurality of air blowing devices and an air blowing direction changeable means provided between the plurality of air blowing devices and a plasma display panel, and
the air blowing means is a means for using, during an aging, the air blowing direction changeable means to change the direction of air blown from the plurality of air blowing devices.

9. The aging device of a plasma display panel according to claim 6, wherein the air blowing means includes a plurality of air blowing devices, and
the air blowing means is a means for moving, during an aging, at least one of the plurality of air blowing devices.

10. The aging device of a plasma display panel according to claim 6, wherein the air blowing means includes a plurality of air blowing devices, and
the air blowing means is a means for changing, during an aging, the direction of at least one of the plurality of air blowing devices.
